(19) United States
(12) Patent Application Publication
(10) Pub. No.: US 2005/0173319 A1
(43) Pub. Date: Aug. 11, 2005

(54) Crossflow filtration system with quick dry change elements

(76) Inventors: Karl Fritze, Denmark Township, MN (US); Nathan E. Marks, Savage, MN (US)

Correspondence Address: CUNO INCORPORATED, 400 RESEARCH PARKWAY, P. O. BOX 1018, MERIDEN, CT, 06450-1018, US

(21) Appl. No.: 11/026,502

(22) Filed: Dec. 30, 2004

Related U.S. Application Data
(63) Continuation-in-part of application No. 10/838,140, filed on May 3, 2004.
(60) Provisional application No. 60/467,663, filed on May 2, 2003.

(51) Int. Cl. B01D 63/06

(52) U.S. Cl. 210/137; 210/257.2; 210/321.65; 210/443; 210/652

(57) ABSTRACT

A crossflow filtration system including at least one quick dry change crossflow filtration cartridge designed to rotatably interface with a manifold assembly. The quick dry change crossflow filtration cartridge can comprise a membrane element, for example an ultrafiltration membrane, microfiltration membrane, nanofiltration membrane or high-flux reverse osmosis membrane element enclosed within a housing. The quick dry change cartridge includes an inlet stream, a permeate stream and a concentrate stream. The manifold assembly includes three similar flow paths; an inlet stream, a permeate stream and a concentrate stream. When engaged, the cartridge and manifold assembly define continuous inlet flow paths, permeate flow paths and concentrate flow paths that connect across the interface. Thus, all of the connections to the water filtration system can be made onto the manifold, and the resulting connected system is compact and easy to connect.

The present application is a Continuation-In-Part application of U.S. patent application Ser. No. 10/838,140, filed May 3, 2004 and entitled “CROSSFLOW FILTRATION SYSTEM WITH QUICK DRY CHANGE ELEMENTS“, which claims the benefit of U.S. Provisional Application No. 60/467,663, filed May 2, 2003 and entitled “RESIDENTIAL REVERSE OSMOSIS SYSTEM WITH QUICK DRY CHANGE ELEMENTS,” both of which are herein incorporated by reference to the extent not inconsistent with the present disclosure.

### BACKGROUND OF THE DISCLOSURE

The present disclosure relates generally to the field of water filtrations systems. More specifically, the present disclosure relates to crossflow filtration systems utilizing a crossflow filtration element, which in some representative embodiments are capable of being added and replaced by a quick connect attachment. Furthermore, in some representative embodiments, the crossflow filtration systems are capable of enhanced filtration capacity with the use of a storage tank and decreased pressure differentials for shutting off flow to the storage tank.

Water filtration systems designed, for example, for use in the home are well known. Due to increasing concerns with regard to water quality, be it supplied by a well or a municipality, the popularity of such systems has increased markedly. Some water filtration systems incorporate reverse osmosis filtration. Reverse osmosis systems can also be used in commercial contexts.

In some configurations, reverse osmosis systems include a reverse osmosis membrane assembly, a pressure tank, a control element, an optional purified water faucet and a tubing/piping assembly defining the various flow paths. In general, an inlet water source is supplied to the membrane assembly where it is separated into a purified water stream (commonly referred to as permeate) and a concentrated waste stream (commonly referred to as concentrate). The permeate may flow to a pressure tank where it can subsequently be accessed through the pure water faucet, a faucet of a home water delivery system or a commercial delivery system. The concentrate can be piped directly to drain or the like. The control element working in conjunction with a series of valves in the tubing/piping assembly and the pure water faucet generally operates the system and may include various monitoring sensors, for example conductivity/resistivity and flow sensors to insure the system is functioning properly.

### SUMMARY OF THE DISCLOSURE

The present disclosure comprises a crossflow filtration system, for example a residential crossflow filtration system, including at least one quick dry change crossflow filtration cartridge designed to rotatably interface with a manifold assembly. The quick dry change crossflow filtration cartridge can comprise a membrane element, for example an ultrafiltration membrane, microfiltration membrane, nanofiltration membrane or reverse osmosis membrane element enclosed within a housing. A rotatably engaging cartridge fastener has two mated elements with one element attached to the housing of the filtration cartridge and the mated second element of the fastener attached to a docking port on the manifold. The housing includes a housing cap having the first fastener element for rotatably connecting to the mated second fastening element at the docking port on the manifold assembly. The fastener can comprise a variety of designs of mated elements, for example, angled tabs, grooves, helical threads, multi-stage engagement members using threads and/or tabs and combinations thereof. Similarly, the mated second fastening element can comprise corresponding mated elements, such as angled tabs, grooves, ramps, multi-stage engagement members or combinations thereof, for interfacing with the first fastener element. The port on the manifold can also comprise a variety of capture mechanisms such that the cartridge fastener does not disengage unintentionally. Examples of appropriate rotatably engaging cartridge fasteners contemplated for use with the water purification systems described herein include, for example, those disclosed in U.S. patent application Ser. Nos. 09/618,686, 10/196,340, 10/202,290 and 10/406,637, all of which are hereby incorporated by reference in their entirety.

The quick dry change cartridge includes three flow paths within the housing and a crossflow filtration media element. The three flow paths include an inlet stream, a permeate stream and a concentrate stream. The manifold assembly includes three similar flow paths; an inlet stream, a permeate stream and a concentrate stream. When engaged, the cartridge and manifold assembly define continuous inlet flow paths, permeate flow paths and concentrate flow paths that connect across the interface. Thus, all of the connections to the water filtration system can be made onto the manifold, and the resulting connected system is compact and easy to connect. In contrast, reverse osmosis designs with a separate condensate drain are represented by U.S. Pat. Nos. 3,746,640, 4,391,712, 4,876,002, 5,122,265, 5,435,909, 5,527,450, 5,580,444 and 6,436,282, all of which are hereby incorporated by reference in their entirety.

When the filtering capacity of the crossflow filtration media element is consumed, the unitary construction of the cartridge allows for quick and easy replacement with a new cartridge containing a new crossflow filtration media element. As there is no disassembly of the cartridge filter, the replacement process can be accomplished without water spillage. In addition, the time required is only that necessary to rotatably remove a spent cartridge and rotatably install a new cartridge. Generally, disassembly and reassembly of the housing and filter cartridge can be performed by hand without any tool, although a tool can be used if desired. In certain embodiments, the filtering characteristics of the crossflow filtration system can be adjustably varied by replacing a cartridge filter having a first media with a new cartridge filter having a second type of filtration media. In addition, operational performance of the crossflow filtration system can be adjusted, which may be desired due to changes in the feedwater chemistry, simply by replacing cartridge filters wherein the cartridge filter includes a specific orifice, thereby controlling overall recovery of the crossflow filtration system. Adjustment can be performed by varying the backpressure on the concentrate stream, for example, by using a flow restrictor such as an orifice or valve.

In a first aspect, the disclosure pertains to a crossflow filtration system comprising a crossflow cartridge filter and a manifold. The crossflow cartridge filter can comprise a housing, an enclosed crossflow filtration media and a first fastener element defining three filter connections that are respectively in fluid communication with a filter feed channel, a filter permeate channel and a filter concentrate channel passing within the cartridge filter. The manifold can comprise a second fastener element mated with the first fastener element, the manifold having three manifold flow channels that connect respectively to three manifold connections on the second fastener element. The three manifold connections connect on a one-to-one basis with the three filter connections when the first fastener element is engaged with the second fastener element.

In another aspect, the disclosure pertains to a crossflow filtration filter comprising a filter housing, a crossflow filtration element and a filter cap. The crossflow filtration element can comprise a crossflow filtration media such as a microfiltration membrane, an ultrafiltration membrane, a nanofiltration membrane or a reverse osmosis membrane. The filter cap can include channels for directing and distributing a feed water stream, a concentrate stream and a permeate stream. The filter cap can further comprise engagement members allowing for interconnection, for example rotatable engagement, with a filter manifold.

In another aspect, the disclosure pertains to a crossflow filtration manifold comprising a manifold body and a manifold connection. The manifold body and the manifold connection can define a feed flow channel, a permeate flow channel and a concentrate flow channel. The manifold connection can include an engagement member for allowing rotatable connection with a cartridge filter. The crossflow filtration manifold can include a flow restriction, such as a valve or orifice, in the concentrate flow channel to backpressure and control the water recovery for a crossflow filtration cartridge. The crossflow filtration manifold can include a biased closed valve in the feed flow channel to prevent water spillage when the manifold is not engaged with a cartridge filter. The crossflow filtration manifold can include a check valve in the permeate flow channel to prevent backward flow of filtered water through the manifold.

In another aspect, the disclosure pertains to a method for forming a water filtration system with a crossflow filter. The method comprises connecting the crossflow filter to a manifold such a feed flow circuit, a permeate flow circuit and a concentrate flow circuit are formed and isolated by a crossflow filtration media.

In another aspect, the disclosure pertains to a reverse osmosis filtration system capable of providing desirably stringent performance characteristics with respect to daily flow capacity and contaminant removal efficiency in a reduced footprint in comparison to previously commercially available systems. The reverse osmosis filtration system comprises a reverse osmosis cartridge filter that may have a high-flux reverse osmosis membrane capable of filtering increased amounts of water at commonly available inflow pressures such as, for example, from about 40 psig to about 120 psig. Through the use of high-flux reverse osmosis membrane, a typical filtered water output of at least 11 gallons per day can be provided in a cartridge filter not exceeding an average of 8 inches in length and not exceeding an average of 1.6 inches in diameter when evaluated at a reference inlet pressure of 50 psig while meeting accepted National Sanitation Foundation standards.

In another aspect, the disclosure pertains to a pressure damping assembly for use in damping pressure fluctuations within a water treatment system. The pressure damping assembly can be fluidly connected between a storage tank and a shut-off valve so as to reduce or eliminate the effect of pressure fluctuations when filtered water is drawn from the storage tank. By reducing or eliminating pressure fluctuations before they reach the shut-off valve, undesirable chattering of the shut-off between system open and system closed configurations can be eliminated. In some presently preferred representative embodiments, the pressure damping assembly can comprises a stand-alone assembly for fluidly mounting between the storage tank and the shut-off valve. In some alternative presently preferred representative embodiments, the pressure damping assembly can integral to the shut-off valve or to a manifold assembly in which the shut-off valve is operably attached. In some presently preferred representative embodiments, the pressure damping assembly can comprise a series of ribs and openings within a fluid conduit defining a winding path in which pressure fluctuations are dampened prior to effecting the shut-off valve.

In some aspects, embodiments of the present disclosure pertain to a reverse osmosis filtration system comprising an inflow conduit, a concentrate outflow conduit, a permeate outflow conduit, a permeate storage tank operably connected to the permeate outflow conduit, a valve controlling flow through the filtration system, a filtration cartridge with operable connections to the inflow conduit, the concentrate outflow conduit and the permeate outflow conduit, and a pressure fluctuation damper within the permeate outflow conduit. Similarly, aspects of the disclosure can pertain to a method for the performance of a reverse osmosis system comprising a permeate storage tank operatively connected to a permeate outflow channel and a pressure regulating valve operatively connected to the permeate outflow channel and an inflow channel that closes flow to the permeate storage tank when the pressure differential between the permeate outflow channel and the inflow channel drops below a predetermined value. The method can comprise installing a pressure fluctuation damping assembly along the permeate outflow channel.

### BRIEF DESCRIPTION OF THE DRAWINGS

FIG. 1 is a side view of a crossflow filtration assembly.

FIG. 2 is an exploded, perspective view of a crossflow cartridge filter.

FIG. 3 is a sectional, side view of a filter housing.

FIG. 4 is a sectional, side view of a crossflow filtration element.

FIG. 5 is a sectional, side view of a filter dam.

FIG. 6 is a sectional, side view of a filter cap.

FIG. 7 is a top, end view of the filter cap of FIG. 6.

FIG. 8 is a bottom, end view of the filter cap of FIG. 6.

FIG. 9 is a sectional, side view of a crossflow cartridge filter.

FIG. 10 is an exploded, perspective view of a manifold assembly.

FIG. 11 is a perspective view of a distributing member.

FIG. 12 is a side view of a connecting member.

FIG. 13 is a perspective view of the connecting member of FIG. 12.

FIG. 14 is a sectional, side view of the connecting member of FIG. 12.

FIG. 15 is a perspective, end view of the manifold assembly of FIG. 10.

FIG. 16 is a side view of the manifold assembly of FIG. 10.

FIG. 17 is a sectional, side view of the manifold assembly of FIG. 10 taken along line A-A of FIG. 16.

FIG. 18 is a sectional, side view of the crossflow filtration assembly of FIG. 1.

FIG. 19 is a schematic diagram of a water treatment system including a crossflow filtration assembly.

FIG. 20 is an exploded, perspective view of an embodiment of a water treatment system.

FIG. 21 is a schematic diagram of a water treatment system including a pressure damping apparatus.

FIG. 22 is a plan view of a portion of a shut-off valve assembly including an integral pressure damping apparatus.

FIG. 23 is a perspective view of a portion of the shut-off valve assembly of FIG. 22.

FIG. 24 is a side view of a portion of the shut-off valve assembly of FIG. 22.

FIG. 25 is a section view of a portion of the shut-off valve assembly of FIG. 22 taken at line 25-25 of FIG. 22.

FIG. 26 is a section view of a portion of the shut-off valve assembly of FIG. 22 taken at line 26-26 of FIG. 22.

### DETAILED DESCRIPTION OF THE PRESENTLY PREFERRED EMBODIMENTS

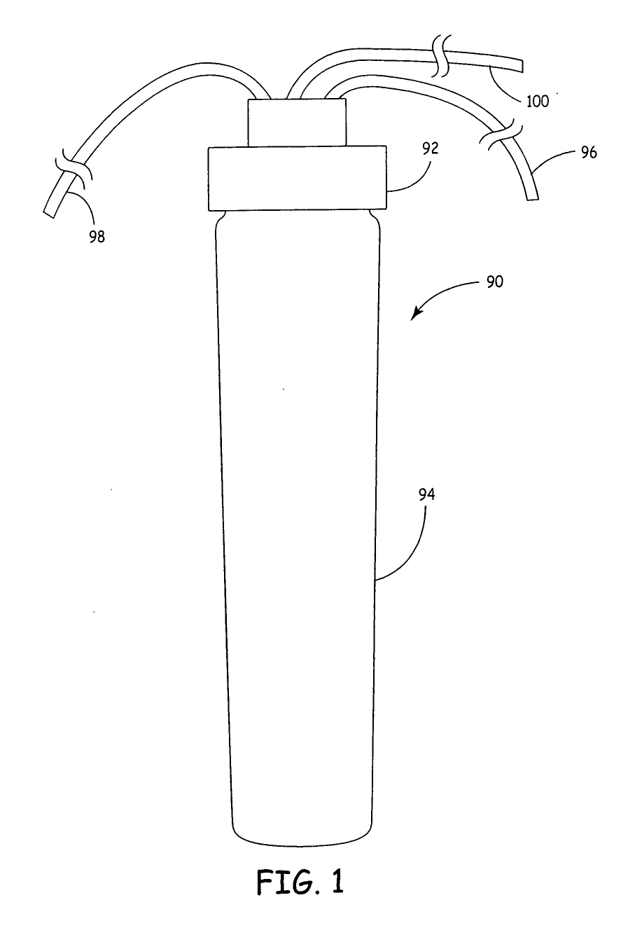

As illustrated in FIG. 1, an embodiment of a crossflow filtration assembly 90 of the present disclosure comprises a manifold assembly 92 and at least one crossflow cartridge filter 94. As depicted in FIG. 1, an embodiment of the crossflow filtration assembly 90 includes a supply tube 96, a concentrate tube 98 and a permeate tube 100.

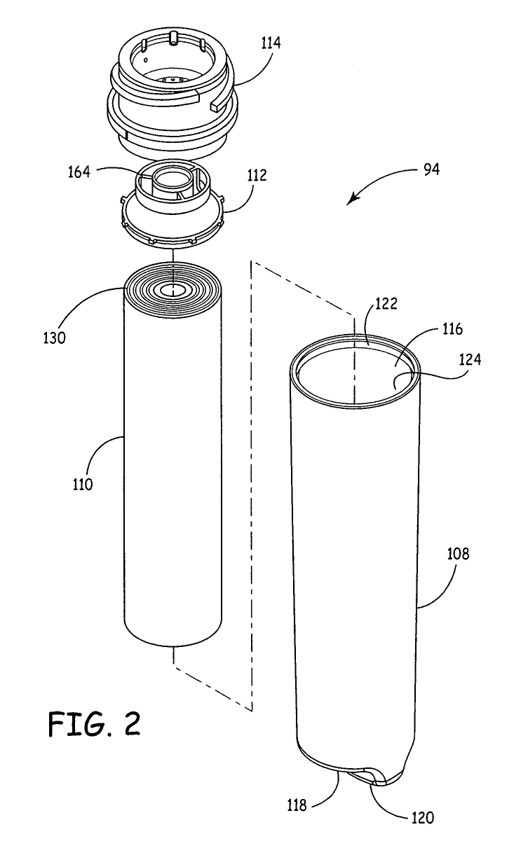

The crossflow cartridge filter 94 is more clearly illustrated in FIG. 2. Generally, crossflow cartridge filter 94 comprises a filter housing 108, a crossflow filtration element 110, a flow director 112 and a filter cap 114. Filter housing 108, flow director 112 and filter cap 114 are constructed of suitable polymers for example, polypropylene or polyethylene. Crossflow cartridge filter 94 is constructed so as to be fixedly sealed and closed such that when replacement is necessary, the entire cartridge is replaced as opposed to replacing individual cartridge components such as crossflow filtration element 110. This system has a single filter element. Different systems can incorporate different numbers of filter elements, such as two, three, four or more of the same or different types, as well as holding tanks. One particular design with multistage filtration is described further below.

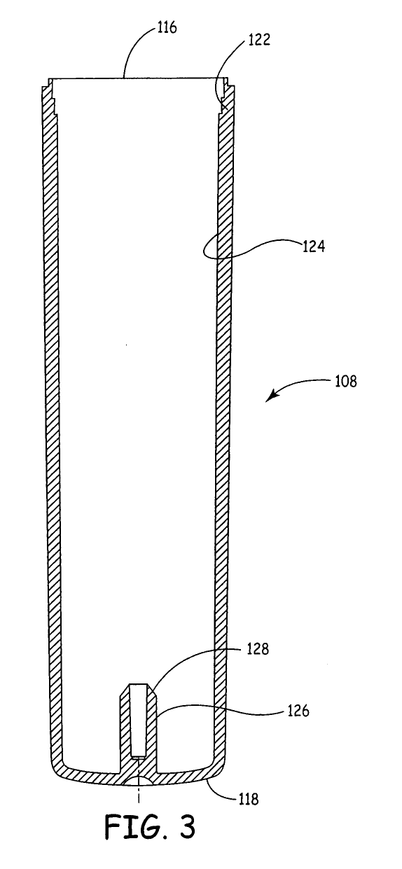

As is shown in FIGS. 2 and 3, filter housing 108 comprises a molded polymeric structure having an open end 116 and a closed end 118. In some embodiments, filter housing 108 comprises a gripping element 120 as shown in FIG. 2, for example a projecting surface, on closed end 118. Open end 116 can include an internal circumferential notch 122 to promote the interconnection and assembly of crossflow cartridge filter 94. Filter housing 108 generally can have a smooth inner wall 124 and can include an internal projection 126 protruding upward from the internal surface of closed end 118, as shown in the cross-sectional view of FIG. 3. Internal projection 126 can comprise a tapered guide surface 128 for use during assembly of crossflow cartridge filter 94.

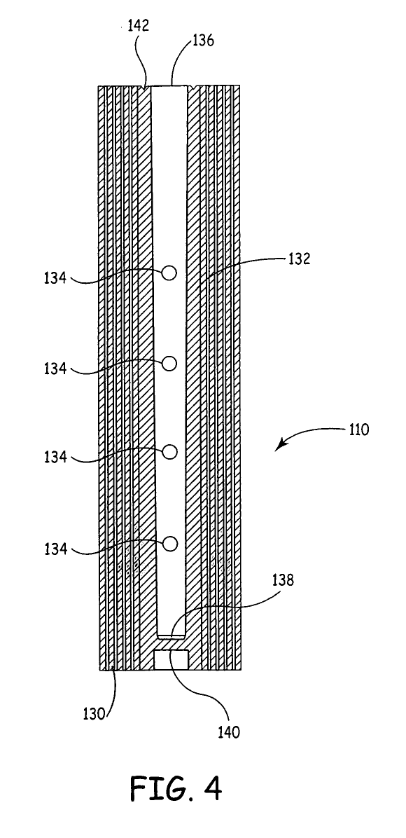

As depicted in FIG. 4, crossflow filtration element 110 can comprise a spirally wound design referred to as a spiral wound element, in which a crossflow filter membrane media 130 is glued to and wrapped around an interior permeate tube 132 having one or a plurality of tube bores 134. Permeate tube 132 has a cylindrical configuration including an open tube end 136, a closed end 138 and a tube recess 140. At open tube end 136, permeate tube 132 includes a weld channel 142. A tube recess 140 can be dimensioned to accommodate insertion of internal projection 126 of filter housing 108 (FIG. 3) during assembly. For purposes of clarity, it is to be understood that the tube bores 134 are located between open end 136 and closed end 138.

In some embodiments, the crossflow filter membrane media 130 can comprise two sheets of membrane, for example sheets of reverse osmosis, nanofiltration, ultrafiltration or microfiltration membrane, sandwiched over a spacer material. The two sheets of membrane can be glued around three sides with a fourth side being open and glued to the permeate tube 132 allowing water to be filtered through the individual flat sheets, into the spacer material, through the tube bores 134 and finally into permeate tube 132. The crossflow filter membrane media 130 can be manufactured of polymers such as cellulose acetate, polyamide and polysulfone. Suitable crossflow filter membrane media 130 is manufactured and sold by companies such as GE Water Technologies (formerly Osmonics, Inc.), Dow Liquid Separations/FilmTec, Hydranautics and Koch Membrane Systems, among others. In alternative embodiments, the crossflow filter membrane 130 can comprise tubular elements and/or sheets of membrane.

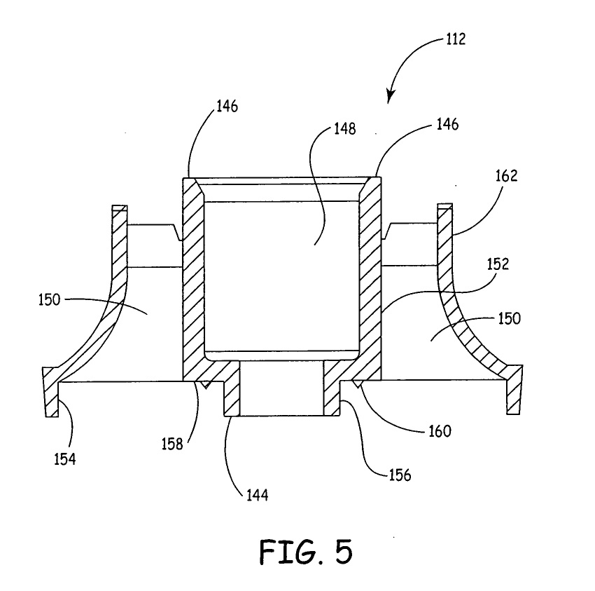

Flow director 112 depicted in FIGS. 2 and 5, comprises a media end 144, a cap end 146, a central throughbore 148 and a plurality of perimeter throughbores 150. Central throughbore 148 and perimeter throughbores 150 are isolated by interior wall 152. Media end 144 has a circular configuration with a diameter slightly greater than open end 136 of interior permeate tube 132 such that a circumferential projecting lip 154 projects around the perimeter of crossflow filtration element 110. Central throughbore 148 interfaces with media end 144 at a projecting sealing surface 156. Projecting sealing surface 156 is dimensioned for insertion into open end 136 and includes a flanged sealing surface 158 having a circumferential weld energy director 160 corresponding to weld channel 142 of interior permeate tube 132. Cap end 146 is defined by end surfaces of an exterior wall 162, interior wall 152 and a plurality of support ribs 164 shown in FIG. 2.

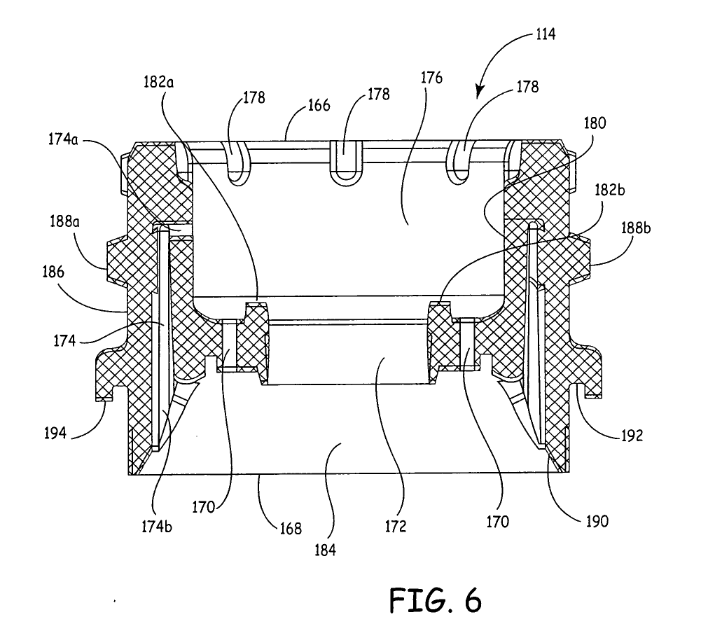

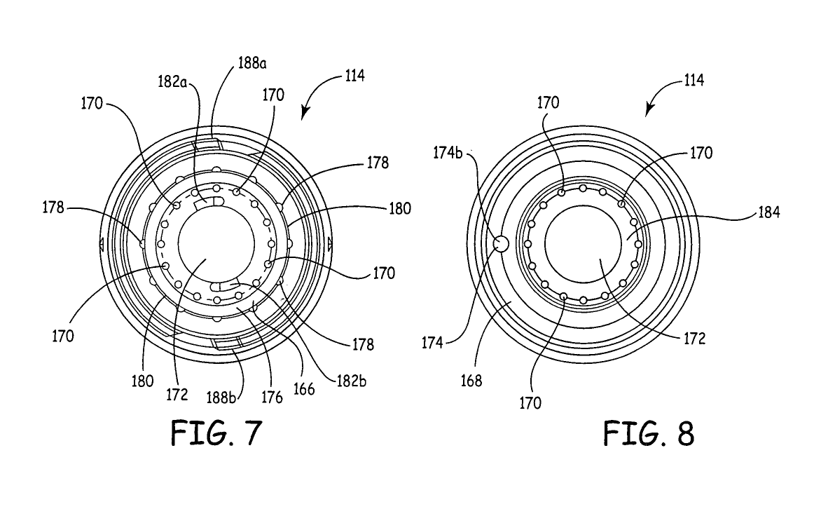

Filter cap 114 depicted in FIGS. 2, 6, 7 and 8 comprises a manifold engagement end 166, a cartridge sealing end 168, a plurality of supply throughbores 170, a central permeate throughbore 172 and a concentrate bore 174. Permeate throughbore 172 is dimensioned to accommodate the insertion of interior wall 152 of filter damn 112. Concentrate bore 174 is defined by an outlet portion 174a and an inlet portion 174b. Outlet portion 174a can comprise a precision drilled or molded bore restriction. Alternatively, an orifice, for example a drilled orifice with an orifice filter, can be mounted within the outlet portion 174a to provide a desired cross-sectional opening with the outlet portion 174a. An interconnecting cavity 176 is exposed at manifold engagement end 166 and includes a plurality of notches 178 along a perimeter wall 180 of interconnecting cavity 176. Also within interconnecting cavity 176 is a pair of arcuate interface ramps 182a, 182b. A sealing cavity 184 is exposed at cartridge sealing end 168 and is dimensioned to accommodate flow director 112. Filter cap 114 includes an exterior surface 186 including a fastening element for connecting with a mated fastening element on the assembly manifold 102. The fastening element can comprise a pair of circumferential ramps 188a, 188b, also depicted in FIG. 2. For interfacing with filter housing 108, the filter cap comprises a circumferential insertion lip 190, a circumferential recess 192 and a circumferential flange 194. While in this embodiment filter damn 112 and filter cap 114 are separate elements, these elements can be formed as a single integral unit.

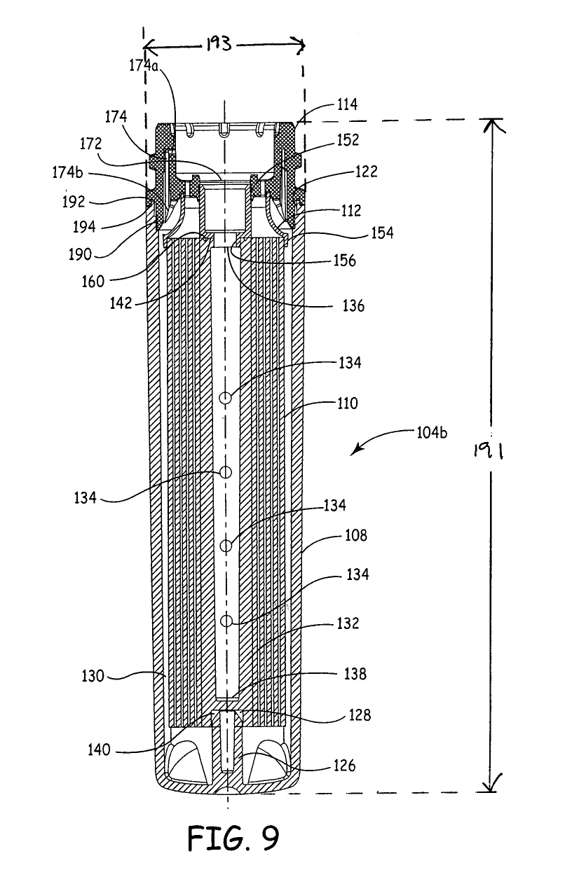

A sectional view of an assembled crossflow cartridge filter 94 is illustrated in FIG. 9. Flow director 112 is positioned with respect to crossflow filtration element 110 such that the projecting sealing surface 156 is slidingly inserted into the open tube end 136. When properly positioned, weld energy director 160 at least partially resides within weld channel 142. Using a suitable welding process, for example spin welding or ultrasonic welding, the weld energy director 160 and weld channel 142 can be attached. At the same time, projecting lip 154 can be sealed by friction bonding and/or the use of a suitable adhesive about the outside of crossflow filtration element 110. Crossflow filtration element 110 is directed into the open end 116 of filter housing 108 such that the internal projection 126 is inserted into the tube recess 140. Filter cap 114 is positioned and directed such that the cartridge sealing end 168 is proximal the cap end 146 and the open end 116, causing slidable insertion of the interior wall 152 into the central permeate throughbore 172. Simultaneously, the circumferential insertion lip 190, circumferential recess 192 and the circumferential flange 194 contact the filter housing 108, for example at internal circumferential notch 122. Using a suitable welding process, for example spin welding or ultrasonic welding, filter cap 114 is welded to filter housing 108 to form the completed crossflow cartridge filter 94. Suitable adhesive sealing methods can also be employed during the assembly of crossflow cartridge filter 94 in addition or as an alternative to a welding process.

When assembled, crossflow cartridge filter 94 defines three distinct flow circuits: a feed water flow circuit, a permeate flow circuit and a concentrate flow circuit. Incoming feed water enters the feed water flow circuit through the supply throughbores 170 such that the feed water flows through the filter cap 114. The feed water then passes through the perimeter throughbores 150 on the flow director 112 and into crossflow filtration element 110. As the feed water passes across the crossflow filter membrane media 130, purified water enters the permeate flow circuit through the tube bores 134 in the interior permeate tube 132. The permeate flow circuit is defined by the interior permeate tube 132, the central throughbore 148 on the flow director 112 and the central permeate throughbore 172 on filter dam 114. Any water that passes across crossflow filtration element 110 without entering the permeate flow circuit flows out the bottom of the crossflow filtration element 110 and into the concentrate flow circuit. The concentrate flow circuit is first defined by the gap between the exterior of the crossflow filtration element 110 and the smooth inner wall 124. The concentrate fluid circuit is further defined by the concentrate bore 174 whereby concentrate is collected and distributed out of the crossflow cartridge filter 94.

In one presently preferred embodiment, crossflow cartridge filter 94 is designed and fabricated so as to occupy a smaller volume while providing comparable flow rates and water quality as previously available reverse osmosis filtration systems. Generally, crossflow cartridge filter 94 has a roughly cylindrical shape, although local or overall variations can be made with respect to the overall cylindrical shape. For example, the ends of the cartridge can have distorted shapes and/or diameters to facilitate attachment or gripping of the cartridge. Similarly, the cartridge can have contouring of its outer surface for aesthetic effects. However, the attachment of the cartridge to a manifold generally establishes an axis of the global cylindrical shape that provides a reference axis for the evaluation of a length and diameter. Thus, a person of ordinary skill in the art can recognize the cylindrical orientation of the cartridge for the evaluation of a length and average diameter.

With reference to FIG. 9, crossflow cartridge filter 94 can be constructed so as to have an overall cartridge length 191 no more than about 8 inches and an average cartridge diameter 193 no more than about 1.6 inches. Furthermore, in some presently preferred representative embodiments, crossflow cartridge filter 94 can have a length of no more than about 7.5 inches, in further embodiments no more than about 7 inches and in additional embodiments from about 4 inches to about 6 inches. In addition, in some presently preferred representative embodiments, crossflow cartridge filter 94 can have an average diameter of no more than about 1.55 inches, in further embodiments no more than about 1.5 inches and in additional embodiments from about 1.2 to about 1.45 inches. A person of ordinary skill in the art will recognize that additional ranges of filter sizes within the explicit ranges above are contemplated and are within the present disclosure.

Crossflow cartridge filter 94 is fabricated so as to produce at least about 11 gallons per day of filtered permeate into a storage tank at typically available residential line pressures such as, for example, from about to 40 psig to about 120 psig, more preferably from about 40 psig to about 80 psig and most preferably from about 40 psig to about 60 psig. More specifically, the crossflow cartridge filter 94 can provide at least about 11 gallons per day of filtered permeate, in other embodiments at least about 15 gallons per day and in further embodiments from about 20 to about 50 gallons per day into a storage tank from a line pressure of 50 psig. Thus, a person of ordinary skill in the art can evaluate a particular crossflow cartridge filter using a reference pressure of 50 psig while allowing flow into a water storage tank. These daily flow rates can be achieved while meeting 2004 U.S. National Sanitation Foundation ANSI 58 water quality standards, described further below. A person of ordinary skill in the art will recognize that additional ranges of flow rates within the explicit ranges above are contemplated and are within the present disclosure.

In order to meet the permeate flow requirement of at least 11 gallons per day with the aforementioned limitations for filter size and residential line pressure, crossflow cartridge filter 94 can comprise a high flow design. This high flow design through two primary design methodologies used either individually or in combination. In a first high flow design methodology, crossflow filter membrane media 130 can be constructed with a spacer material selected so as to have a minimum possible cross-sectional width such that the combination of the spacer material and membrane sheets provide a minimum cross-sectional width to the crossflow filter membrane media 130. By utilizing a crossflow filter membrane media 130 with the minimum possible cross-sectional width, more square footage of the membrane media can be rolled into and included with the crossflow filtration element 110. By providing more membrane media, more permeate flow can be generated. In a second high flow design methodology, the crossflow filtration element 110 can be fabricated by selectively incorporating a high-flux membrane. A high flux membrane is capable of generating an increased amount of permeate flow as compared to a conventional crossflow membrane while maintaining equivalent rejection performance as the conventional crossflow membrane. When using such a high flux membrane, a lesser amount of membrane is required to achieve a desired flow rate, and consequently, a reduced size crossflow cartridge filter 94 can be utilized than what is available in present reverse osmosis filtration systems. High flux membrane can be fabricated of suitable polymers such as, for example, polyamide membrane and cellulose acetate membrane. High-flux membranes, characteristics and methods for manufacturing are further disclosed in WIPO Patent Cooperation Treaty application serial numbers WO 2003/101575A2, WO 2003/101575A3 and WO 2003/101575C2, each of which is herein incorporated by reference to the extent not inconsistent with the present disclosure

Using a presently preferred embodiment of the crossflow cartridge filter 94 comprising a crossflow filtration element 110 with high-flux membrane, the following flow and rejection performance can be achieved. According to Table 1, the properties of the purified water are tested by accepted analytical techniques under NSF International per NSF/ANSI Standard 58 with the maximum values in the Table being the maximum allowed values under the standard. The 2004 ANSI 58 standards are hereby incorporated by reference in their entirety, except to the extent not inconsistent with the present disclosure of the RO system design. Performance characteristics of the filters are referenced to NSF required influent values, which are provided in the Table with a variance of ±10 percent unless indicated otherwise.

TABLE 1
Maximum Flow and Rejection Performance
with High-Flux Membrane

| | | Maximum Effluent |
|---|---|---|
| | NSF Specified | Concentration |
| | Influent | (mg/L except |
| Contaminant | (mg/L) | where noted) |
| Arsenic⁽¹⁾ | 0.30 | 0.025 |
| Asbestos | 10⁷ to 10⁸ | 99% |
| | MF/L⁽⁴⁾ | |
| Barium⁽¹⁾ | 10 | 2.0 |
| Cadmium⁽¹⁾ | 0.03 | 0.005 |
| Chromium (Hexavalent)⁽¹⁾ | 0.3 | 0.1 |
| Chromium (Trivalent) | 0.3 | 0.1 |
| Copper | 3.0 | 1.3 |
| Cysts⁽¹⁾ | >=50,000 | 99.95% |
| | #/mL⁽⁵⁾ | |
| Turbidity⁽²⁾ | 11 +/− 1 | 0.5 NTU |
| Radium⁽³⁾ | 25 pCi/L | 5 pCi/L |
| Lead | 0.15 | 0.010 |
| Nitrate | 27.0 | 10 |
| Nitrite | 3.0 | 1 |
| Nitrate + Nitrite | 30.0 | 10 |
| Selenium | 0.10 | 0.05 |
| TDS | 750 +/− 40 | 187 |
| Ammonium | 1.2 | 1.0 |
| Bicarbonate | 300 | 100 |
| Bromide | 1.5 | 3.3 |
| Chloride | 800 | 250 |
| Chlorine | 2.0 | 0.67 |
| Magnesium | 30 | 10 |
| Sodium | 350 | 117 |
| Sulfate | 800 | 250 |
| Tannin | 3.0 | 1.0 |
| Zinc | 15 | 5.0 |

Concentration (mg/L) unless otherwise specified
Notes:
⁽¹⁾Based on percent reduction
⁽²⁾NTU is Nephelometric Turbidity Units
⁽³⁾pCi/L is pico-Curies per liter
⁽⁴⁾MF/L = Million Fibers per Liter
⁽⁵⁾#/mL = Particles per milliliter

Table 2 has the general operating specifications typical for residential reverse osmosis filtration systems as described herein. Generally, the flow capacities described herein are evaluated at room temperature or 72 degrees F.

TABLE 2
Operating Specifications

| Inlet Pressure | 40-120 psig (2.8-7.0 kg/cm²) |
|---|---|
| Inlet Temperature | 40-100° F. (5-38° C.) |
| Maximum TDS Level | 2000 mg/L |
| Maximum Hardness @ 6.9 pH | 10 grains per gallon (171 mg/L) |
| Maximum Chlorine | 2.0 mg/L |
| pH Range | 4-10 |
| Daily Production Rate | 11 gal/day |
| Efficiency Rating⁽¹⁾ | 12.5 |
| Recovery Rating⁽²⁾ | 25.5 |

⁽¹⁾Efficiency rating means the percentage of the influent water to the system that is available to the user as reverse osmosis treated water under operating conditions that approximate typical daily usage.
⁽²⁾Recovery rating means the percentage of influent water to the membrane portion of the system that is available to the user as reverse osmosis treated water when the system is operated without a storage tank or when the storage tank is bypassed.

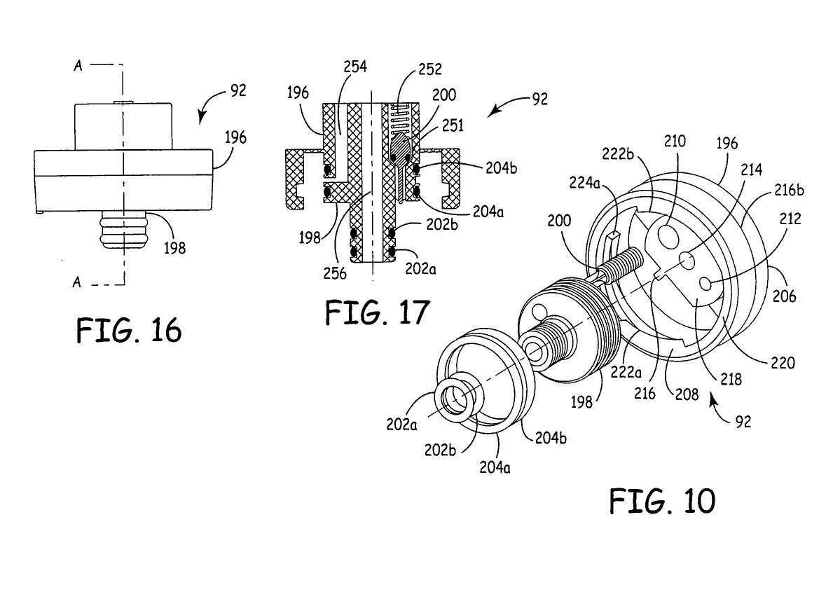

As illustrated in FIG. 10, an embodiment of manifold assembly 92 can comprise a distributing member 196, a connecting member 198, a spring loaded valve 200, a pair of first O-ring seals 202a, 202b and a pair of second O-ring seals 204a, 204b.

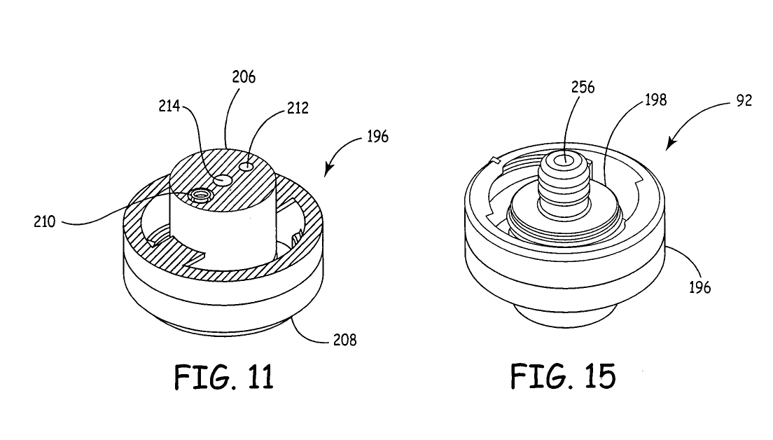

Distributing member 196 is illustrated in FIGS. 10 and 11. Distributing member 196 has a distribution end 206 and a connection end 208. Extending between the distribution end 206 and the connection end 208 are a distribution feed throughbore 210, a distribution concentrate throughbore 212 and a distribution permeate throughbore 214. Located on connection end 208 is a pair of attachment projections 216. Connection end 208 further includes a connecting surface 218 and a perimeter distribution wall 220. Perimeter distribution wall 220 includes a filter receiving means, shown as a pair of tabs 222a, 222b and a pair of sloped members 224a, 224b.

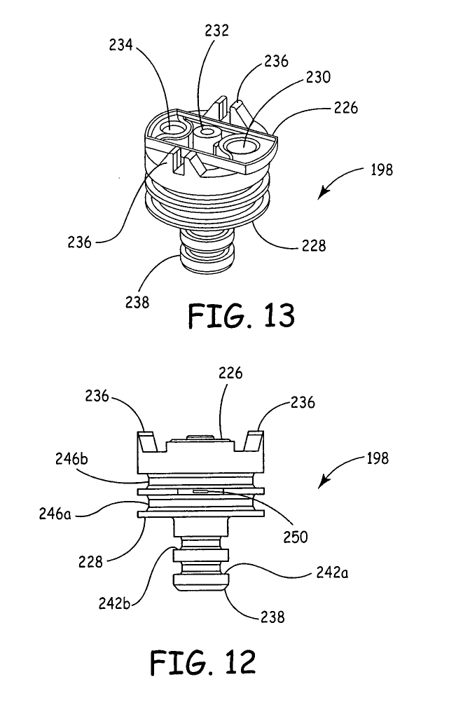

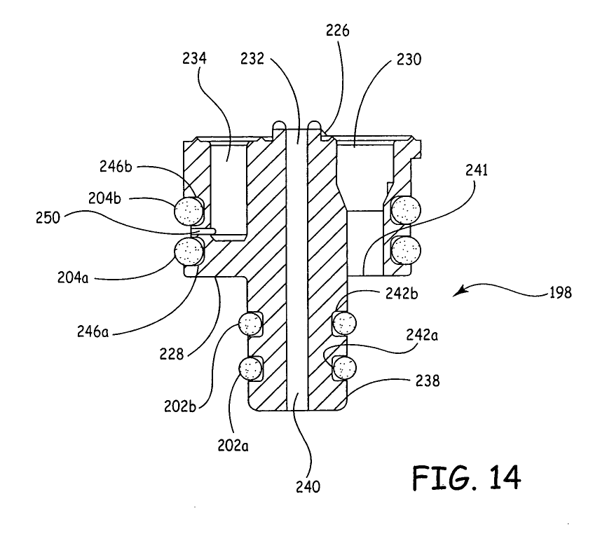

Connecting member 198, as shown in FIGS. 12, 13 and 14, includes a manifold attachment end 226 and a filter attachment end 228. Manifold attachment end 226 includes a feed inlet bore 230, a permeate outlet bore 232 and a concentrate outlet bore 234. Manifold attachment end 226 further includes a pair of manifold attachment members 236 for interconnection of the connecting member 198 to the distributing member 196. Filter attachment end 228 includes a connector projection 238 with a permeate throughbore 240 in fluid connection with the permeate outlet bore 232. Filter attachment end 228 further includes a feed outlet bore 241. Connector projection 238 has a pair of circumferential projection grooves 242a, 242b for receiving the O-ring seals 202a, 202b. Connector projection 238 has a diameter such that connector projection 238 inserts into the central permeate throughbore 172. Connecting member 198 includes a pair of circumferential body grooves 246a, 246b for receiving O-ring seals 204a, 204b. Located between circumferential body grooves 246a, 246b is a concentrate inlet bore 250.

Manifold assembly 92 is generally constructed as shown in FIGS. 10, 15, 16 and 17. Distributing member 196 is oriented such that the connection end 208 is facing the manifold attachment end of the connecting member 198. The spring loaded valve 200 is positioned such that it is captured and resides on a valve seat 251 within the distribution feed throughbore 210 and the feed inlet bore 230 as the distributing member 196 and the connecting member 198 are coupled. As the distributing member 196 and the connecting member 198 come into contact, the manifold attachment members 236 slide over the attachment projections 216. Once the connection end 208 and the manifold attachment end 226 are in physical contact, the distributing member 196 and the connecting member 198 are joined with a suitable joining technique, for example sonic welding and/or adhesive bonding. When the distributing member 196 and the connecting member 198 are operably joined, a continuous manifold feed channel 252 is defined by the distribution feed throughbore 210, the feed inlet bore 230 and the feed outlet bore 241; a continuous manifold concentrate channel 254 is defined by the concentrate inlet bore 250, the concentrate outlet bore 234 and the distribution concentrate throughbore 212; and a continuous manifold permeate channel 256 is defined by the permeate throughbore 240, the permeate outlet bore 232 and the distribution permeate throughbore 214. In alternative embodiments, the distribution member and the connection member can be formed as a single integral unit.

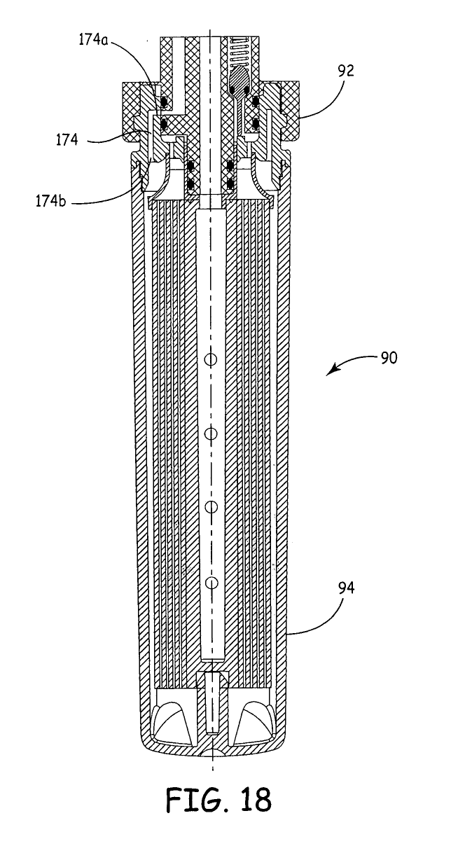

Following the assembly and plumbing of manifold assembly 92, the crossflow cartridge filter 94 is sealingly attached to the manifold assembly 92 as shown in FIG. 18. In one embodiment, the crossflow cartridge filter 94 is rotatably coupled to the manifold assembly 92. Crossflow cartridge filter 94 is positioned and aligned such that central throughbore 148 is in alignment with and proximate to connector projection 238. Connector projection 238 is slidably inserted into central throughbore 148 such that circumferential ramps 188a, 188b physically contact tabs 222a, 222b. Crossflow cartridge filter 94 is rotatably biased such that circumferential ramp 188a is captured between tab 222a and sloped member 224a while circumferential ramp 188b is simultaneously captured between tab 222b and sloped member 224b. Further rotation of crossflow cartridge filter 94 causes approximation of the crossflow cartridge filter 94 and the manifold assembly 92 such that connector projection 238 is fully inserted into central throughbore 148. Ultimately, the first pair of O-ring seals 202a, 202b create a fluid tight seal between connector projection 238 and central throughbore 148 to prevent water leakage. As connector projection 238 is fully inserted into central throughbore 148, either arcuate interface ramp 182a or 182b contacts the spring loaded valve 200. As crossflow cartridge filter 94 is rotated, arcuate interface ramp 182a or 182b causes spring loaded valve 200 to compress such that the spring loaded valve 200 is lifted from the valve seat 251. As spring loaded valve 200 is lifted from valve seat 251, feed water can begin to flow into the manifold assembly 92.

Once the crossflow filtration assembly 90 is assembled, feed water can begin to flow into the manifold assembly 92 through the supply tube 96. The feed water flows past the spring loaded valve 200 within the manifold feed channel 252 and enters the crossflow cartridge filter 94 through the supply throughbores 170. The feed water enters the crossflow filtration element 110 such that some water is directed through the membrane media 130. As the water travels the length of crossflow filtration element 110, the water volume decreases while the number of contaminants present within the water flow increases. At the end of the crossflow filtration element 100 nearest the closed end 118, the concentrated feed water flows from the crossflow filtration element 110 to form a concentrate stream having a high concentration of contaminants. At the same time, purified water that has passed through the membrane media 130 is collected within the interior permeate tube 132 to form a permeate stream, essentially free of contaminants.

The concentrate stream flows between the crossflow filtration element 110 and the inner wall 124. By directing the concentrate stream in the gap between the crossflow filtration element 110 and the inner wall 124, the potential for deadspots or regions of stagnant water is eliminated. By eliminating deadspots, the potential for biological growth and contamination within the crossflow filtration element 110 is minimized. The concentrate stream enters the circumferential concentrate bore 174 whereby the concentrate stream flows into the concentrate inlet bore 250. O-ring seals 204a, 204b prevent the concentrate stream from contaminating either the feed stream or the permeate stream. From the concentrate inlet bore 250, the concentrate stream is directed through the manifold concentrate channel 254 and to drain through the concentrate tube 98. At various points, either within the manifold assembly 92 or the crossflow cartridge filter 94, a restriction can be placed within the concentrate flow stream to backpressure the concentrate stream such that the volume of the permeate stream can be increased or decreased. For example, this restriction can take the form of a fixed or adjustable orifice located in first portion 174a, or a valve within the manifold assembly 92. The restriction is typically adjusted based on the water quality of the feed supply. For a high quality feed supply, the volume of the permeate stream can be increased as opposed to a feed water supply of a lower quality. For example, where the feed supply is of a poor quality, the recovery can be set at a relatively low recovery percentage such as, for example from about 25% to about 50% recovery. With reference to a recovery percentage of about 50%, the permeate flow rate is about 50% of the flow rate of the feed supply. Where the feed supply is of a higher quality, the recovery can be set at a relatively high recovery percentage such as, from about 75% to about 90% recovery. Many residential water systems provide relatively high quality input water. With reference to a recovery percentage of about 90%, the permeate flow rate is about 90% of the flow rate of the feed supply. In presently preferred representative embodiments, the restriction can supply backpressure so as provided overall system recoveries from about 30% to about 90%, in further embodiments from about 50% to about 90 percent, in other embodiments from about 60% to about 90 percent and in additional embodiments from about 75% to about 90%. A person of ordinary skill in the art will recognize that additional ranges of recovery rates are contemplated and are within the present disclosure.

The purified permneate stream is collected within the interior permeate tube 132 whereby it flows through the central throughbore 148 and into the permeate throughbore 240. Once in the permeate throughbore 240, the permeate stream flows through the manifold permeate channel 256 whereby the permeate stream is directed to points of use by the permeate tube 100. In an embodiment, permeate tube 100 may deliver the permeate stream to a pressurized permeate tank for subsequent distribution to points of use. In the case of a pressurized permeate tank, the manifold assembly 92 could include a checkvalve to prevent any backflow of permeate from the pressurized permeate tank when the crossflow cartridge filter 94 is removed from the manifold assembly 92.

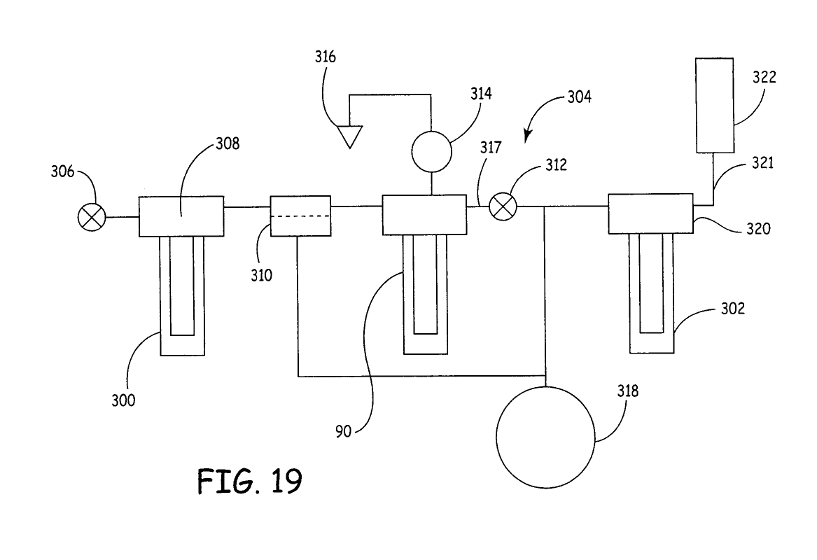

As illustrated in FIG. 19, crossflow filtration assembly 90 can be used in conjunction with a pretreatment filter 300 and a posttreatment filter 302 to form a water treatment system 304. As illustrated, water treatment system 304 can further comprise a feed inlet 306, a pretreatment manifold 308, a shutoff valve 310, a checkvalve 312, a flow restrictor 314, a drain 316, a permeate outlet 317, a storage tank 318, a posttreatment manifold 320, distribution stream 321 and a distribution control 322. The water treatment system 304 can be selectively configured, through the use of various pretreatment filters 300 and posttreatment filters 302 to provide a desired filtered water quality based upon the available feed water quality. For instance, pretreatment filter 300 can include a filter media to remove particulate matter, chlorine, chloramines, organics or hardness. Likewise, posttreatment filter 302 can include filter media to remove any remaining dissolved solids, chlorine, organics and biological material or to removed undesirable taste and/or odor associated with water stored in storage tank 318. Furthermore, pretreatment filter 308 can be configured to increase the permeate recovery of the crossflow filtration assembly 90 such that the flow rate to drain 316 is reduced. The flow restrictor can be used to alter the performance of the filtration medium. In particular, a more restricting flow restrictor can be used to lower the ratio of concentrate flow to permeate flow, while a less restricting flow restrictor increases the ratio of concentrate flow to permeate flow.

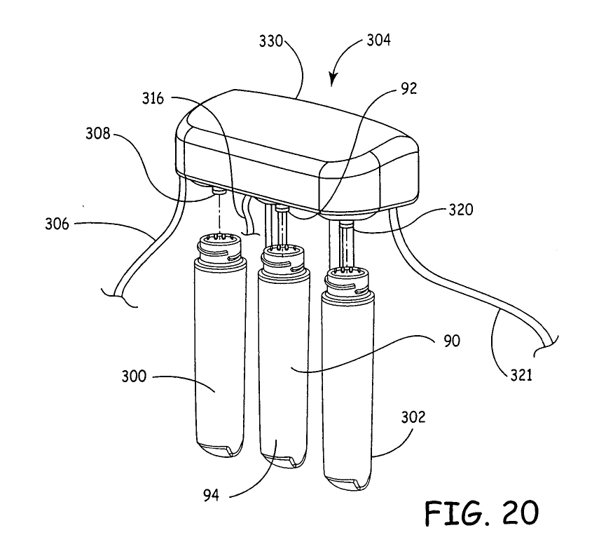

In one alternative embodiment of water treatment system 304 illustrated in FIG. 20, crossflow filtration assembly 90, pretreatment filter 300, posttreatment filter 302, feed inlet 306, pretreatment manifold 308, shutoff valve 310, checkvalve 312, flow restrictor 314, drain 316, posttreatment manifold 320 and distribution stream 321 can be incorporated into a unitary manifold assembly 330. Both pretreatment filter 300 and pretreatment manifold 308 as well as posttreatment filter 302 and posttreatment manifold 320 can make use of quick connect filter and manifold assembly designs having one inlet and one outlet, for example as disclosed in U.S. patent applications Ser. Nos. 09/618,686, 10/196,340, 10/202,290 and 10/406,637.

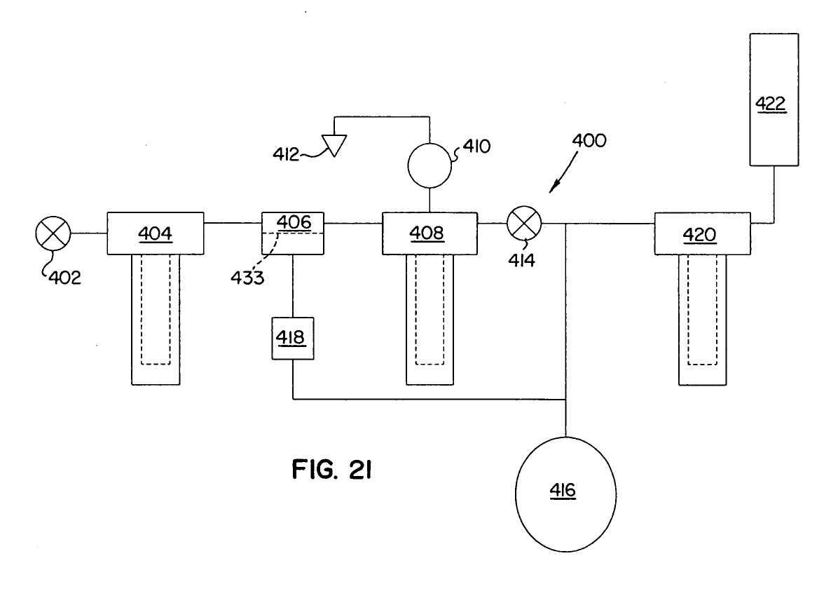

Another alternative embodiment of a water treatment system 400 is illustrated in FIG. 21. Water treatment system 400 can comprise an inlet connector 402, a prefilter assembly 404, a shut-off valve 406, a crossflow filtration assembly 408, a flow restrictor 410, a drain connection 412, a check valve 414, a pressure tank 416, a pressure damping assembly 418, a postfilter assembly 420 and a dispensing assembly 422. In one presently preferred embodiment, inlet connector 402 can comprise a suitable valve assembly such as, for example, a saddle valve. In some presently preferred embodiments, shut-off valve 406 can comprise a diaphragm valve, a double-diaphragm or like valve configurations. Flow restrictor 410 can comprise suitable restrictor designs such as, for example, fixed or adjustable orifice assemblies or valve restrictor assemblies such as, for example, a needle valve assembly. Dispensing assembly 422 can comprise suitable dispensing assemblies such as, for example, manually or automatically controlled dispensers such as a faucet or tap. Dispensing assembly 422 can further comprises a dispensing assembly adapted to automatically feeding automated systems that request water flow such as, for example, an automated icemaker. Prefilter assembly 404, crossflow filtration assembly 408 and postfilter assembly 420 can comprises configurations similar to those previously discuss, for instance, prefilter assembly 404 can substantially resemble pretreatment filter 302, crossflow filtration assembly 408 can substantially resemble crossflow filtration assembly 90 and postfilter assembly 420 can substantially resemble posttreatment filter 302.

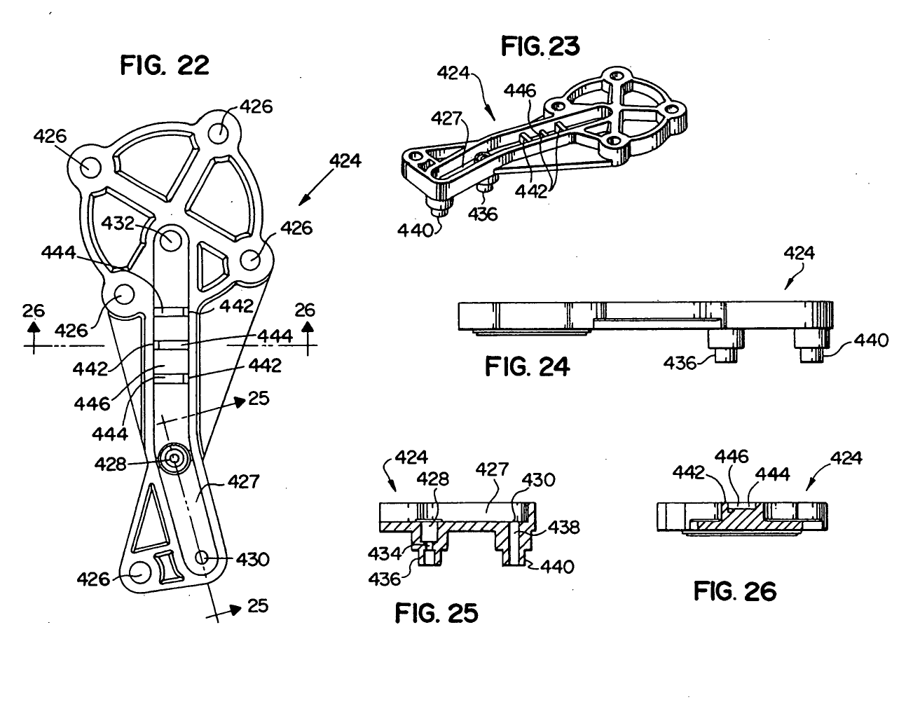

Pressure damping assembly 418 can comprise a flow component adapted so as to provide for a pressure damping function between the pressure tank 416 and the shut-off valve 406. Pressure damping assembly 418 can be constructed so as to comprise a stand-alone component of the water treatment system 400 or pressure damping assembly can be integrally fabricated as part of the shut-off valve 406, which may or may not be fabricated as part of a manifold assembly, for example, manifold assembly 92. For example, a shut-off valve body 424 for integral inclusion with a suitable manifold assembly is illustrated in FIGS. 22, 23, 24, 25 and 26. Shut-off valve body 424 comprises a plurality of attachment bores 426 adapted to receive suitable fasteners for joining the shut-off valve body 424 to a manifold. Alternatively, shut-off valve body 424 can be attached to the manifold through other suitable joining techniques such as, for example, using adhesives, ultrasonic welding, molding and the like.

Shut-off valve body 424 comprises a fluid channel 427 for fluidly connecting a fluid inlet 428, a fluid outlet 430 and a diaphragm interface bore 432. Fluid inlet 428 comprises an inlet bore 434 fluidly connected to an inlet connecting feature 436 while fluid outlet 430 comprises an outlet bore 438 fluidly connected to an outlet connecting feature 440. Diaphragm interface bore 432 is placed into fluid communication with a shut-off diaphragm 433 within the shut-off valve 406. Pressure damping assembly 418, herein illustrated as a plurality of ribs 442 defining flow openings 444 within the fluid channel 427, form a winding fluid path 446 between the fluid inlet 428 and the diaphragm interface bore 432.

With reference to FIG. 21. a user accesses purified water through the dispensing assembly 422. When dispensing assembly 422 is activated, pressurized water within the pressure tank 416 flows through the postfilter assembly 420 and to the user through the dispensing assembly 422. As the volume of pressurized water within pressure tank 416 decreases, an internal bladder within the pressure tank 416 expands wherein backpressure from the pressure tank 416 to the crossflow filtration assembly 408 and to the shut-off valve 406 decreases. Eventually this reduced backpressure from pressure tank 416 results in the shut-off diaphragm 433 within shut-off valve 406 shifting from a closed disposition to an open disposition. In the open disposition, a residential water stream at typical house pressures flows through the inlet connector 402, through the prefilter assembly 404, through the prefilter assembly 404 and to either the dispensing assembly 422 if the user still desires filtered water or to the pressure tank 416. As the pressure tank 416 fills with filtered water, the bladder within the pressure tank 416 is compressed which consequently raises the pressure of the filtered water. Eventually the pressure within the pressure tank 416 reaches a high enough pressure such that the shut-off diaphragm 433 within shut-off valve 406 shifts to the closed disposition wherein the residential water stream is prevented from entering the crossflow filtration assembly 416.

Shut-off diaphragm 433 within shut-off valve 406 can be selectively configured so an increased surface area is exposed to the backpressure from storage tank 416 as opposed to the line pressure associated with the residential water stream. By varying the amount of pressure exposure on each side of the shut-off diaphragm 433, the water treatment system 400 can be configured so as operate within desired fluid pressure ranges and to achieve desired flow rates. However, in some instances, the incompressible nature of water may create pressure waves or spikes within the water treatment system 400 such as, for example, when first dispensing water from the dispensing assembly 422, that interferes with the proper operation of the shut-off valve 406. For instance, dispensing water may result in a near instantaneous drop in pressure within the water treatment system 400 whereby the shut-off diaphragm 433 within shut-off valve 406 shifts to the open disposition and immediately shifts back to the closed disposition after the pressure is restored. In some instances, these pressure spikes may result in the shut-off valve 406 chattering between the open and closed dispositions.

Through the inclusion of pressure fluctuation damping assembly 418, the effects associated with pressure surges and spikes can be avoided or dampened to a point that they do not adversely effect the operation of shut-off valve 406 beyond desired amounts. For example, the combination of ribs 442 and flow openings 446 serve to dampen or eliminate pressure spikes or surges by requiring said spikes or surges to be transmitted through flow path 446. Flow path 446 serves to reduce the pressure fluctuations transmitted through the fluid channel 427 such that the pressure spike or surge either fails to reach the diaphragm interface bore 432 or reaches the diaphragm interface bore 432 at a reduced level that does not effect shifting of the shut-off diaphragm 433. By reducing or eliminating the influence of pressure spikes or surges, pressure damping assembly 418 provides that the pressure drop within the fluid treatment system 400 is equilibrated and transmitted throughout the fluid treatment system 400 before altering the position of the shut-off diaphragm 433 within the shut-off valve 406. In addition, the use of pressure damping assembly 418 within fluid treatment system 400 can allow the shut-off valve 406 to be configured such that the fluid pressures needed to shift shut-off diaphragm 433 between the open disposition and closed disposition can be set within a narrower pressure range than for a fluid treatment system lacking a pressure damping assembly 418 as the pressure spikes or surges are substantially eliminated and/or reduced which can cause chattering of the shut-off-valve 406 when the pressured differences for the open and closed dispositions are minimal. By maintaining minimal pressure differences between the open and closed dispositions of shut-off valve 406, fluid treatment system 400 can more quickly respond and begin filtering water through crossflow filtration assembly 408 when filtered water is requested by dispensing assembly 422 such that the potential for running the pressure tank 416 empty is reduced. While pressure damping assembly 418 has been described and illustrated as a series of ribs and openings, alternative configurations are contemplated such as, for example, fluid chambers arranged in series having variable volumes from that of the fluid channels or the use of capillary tubes mounted inline within the fluid channels so as to provide restrictions and pressure reducing qualities prior to the transmitting fluid pressure to the shut-off valve 406.

Although various embodiments of the present disclosure have been disclosed here for purposes of illustration, it should be understood that a variety of changes, modifications and substitutions might be incorporated without departing from either the spirit or scope of the present disclosure.

1. A reverse osmosis filtration system comprising:
an inflow conduit;
a concentrate outflow conduit;
a permeate outflow conduit;
a permeate storage tank operably connected to the permeate outflow conduit;
a valve controlling flow through the filtration system; and
a filtration cartridge comprising a generally cylindrical housing, a high-flux reverse osmosis filtration membrane within the housing and operable connections to the inflow conduit, the concentrate outflow conduit and the permeate outflow conduit, wherein the cartridge has an average outer diameter of no more than 1.6 inches and an average total length of no more than 8 inches and wherein the filtration system has a permeate outflow capacity of at least about 11 gallons per day at an inflow inline pressure of 50 psig water meeting 2004 U.S. National Sanitation Foundation ANSI 58 quality standards.

2. The reverse osmosis filtration system of claim 1 wherein the permeate outflow capacity is at least about 20 gallons per day.

3. (canceled)

4. The reverse osmosis filtration system of claim 1 wherein the high-flux reverse osmosis filtration membrane has a greater than 89% rejection rate for Total Dissolved Solids.

5. The reverse osmosis filtration system of claim 1 wherein the high-flux reverse osmosis filtration membrane can reduce NSF accepted influent water to have a nitrate level less than 10 milligrams per liter.

6. The reverse osmosis filtration system of claim 1 wherein the permeate flow capacity of 11 gallons per day represents a system recovery of about 25% to about 90% with respect to a supply flow through the inlet conduit.

7. The reverse osmosis filtration system of claim 6 wherein the system recovery is regulated by a flow restrictor fluidly located within the concentrate outflow conduit.

8. The reverse osmosis filtration system of claim 7 wherein the flow restrictor comprises an orifice or a valve assembly.

9. The reverse osmosis filtration system of claim 1 wherein the filtration cartridge is removably attached to a manifold assembly to operably connect the inflow conduit, concentrate outflow conduit and the permeate outflow conduit.

10. (canceled)

11. (Canceled)

12. (canceled)

13. A reverse osmosis filtration cartridge comprising a housing, a high-flux reverse osmosis filtration membrane within the housing and operable connections to the inflow conduit, the concentrate outflow conduit and the permeate outflow conduit, wherein the cartridge has an average diameter of no more than 1.6 inches and an average length of no more than 8 inches and wherein the filtration system has a permeate outflow capacity of at least about 11 gallons per day at an inflow inline pressure of 50 psig when delivering water to a storage tank with water meeting 2004 U.S. National Sanitation Foundation ANSI 58 quality standards.

14. The reverse osmosis filtration cartridge of claim 13 wherein the permeate outflow capacity is at least about 20 gallons per day.

15. (canceled)

16. The reverse osmosis filtration cartridge of claim 13 wherein the operable connections to the inflow conduit, the concentrate outflow conduit and the permeate outflow conduit are all integral to a filter cap operably attached to an open end of the housing.

17. (canceled)

18. (canceled)

19. The reverse osmosis filtration cartridge of claim 13 wherein the high-flux reverse osmosis filtration membrane has a greater than 89% rejection rate for Total Dissolved Solids.

20. The reverse osmosis filtration cartridge of claim 13 wherein the high-flux reverse osmosis filtration membrane

21. The reverse osmosis filtration cartridge of claim 13 wherein the high-flux reverse osmosis filtration membrane comprises a polyamide membrane or a cellulose acetate membrane.

22. A method for forming a reverse osmosis filtration cartridge comprising sealing a high-flux reverse osmosis membrane within a permanently sealed cartridge housing, wherein the membrane is rolled onto a permeate tube operably connected to a permeate outflow and the cartridge comprising an inflow connection and a concentrate outflow connection, wherein the cartridge has an average diameter of no more than about 1.6 inches and an average length of no more than about 8 inches to form a cartridge with a permeate outflow capacity of at least about 11 gallons per day at an inflow inline pressure range of 50 psig when delivering water to a storage tank with water meeting 2004 U.S. National Sanitation Foundation ANSI 58 quality standards.

23. The method of claim 22 wherein the permeate outflow capacity is at least about 20 gallons per day.

24. The method of claim 23 wherein the permeate outflow capacity is from about 20 gallons per day to about 50 gallons per day.

25. The method of claim 22 wherein sealing the high-flux reverse osmosis membrane within the permanently sealed cartridge housing comprises permanently attaching a filter cap to an open end of the cartridge housing such that the high-flux reverse osmosis membrane is retained within the cartridge housing.

26. A reverse osmosis filtration system comprising:
an inflow conduit;
a concentrate outflow conduit;
a permeate outflow conduit;
a permeate storage tank operably connected to the permeate outflow conduit;
a valve controlling flow through the filtration system;
a filtration cartridge with operable connections to the inflow conduit, the concentrate outflow conduit and the permeate outflow conduit; and
a pressure fluctuation damper within the permeate outflow conduit.

27. The reverse osmosis filtration system of claim 26 wherein the pressure fluctuation damper comprises a ribs and openings forming a non-linear path.

28. (canceled)

29. (canceled)
